(19) United States
(12) Patent Application Publication
(10) Pub. No.: US 2002/0028745 A1
(43) Pub. Date: Mar. 7, 2002

(54) PROCESS FOR THE PREPARATION OF HIGH ACTIVITY CARBON MONOXIDE HYDROGENATION CATALYSTS; THE CATALYST COMPOSITIONS, USE OF THE CATALYSTS FOR CONDUCTING SUCH REACTIONS, AND THE PRODUCTS OF SUCH REACTIONS

(76) Inventors: ALLA JURIEVNA KRYLOVA, GRAIVOROVSKAJA (RU); ALBERT L?apos;VOVICH LAPIDUS, KASHIRSKOJE (RU); RUSSELL J. KOVEAL, BATON ROUGE, LA (US); MICHAEL A. DAAGE, BATON ROUGE, LA (US)

Correspondence Address: NORBY L. FOSS, EXXON MOBIL RESEARCH AHD ENGINEERING COMPANY, P O BOX 900, ANNANDALE, NJ, 08801-0900, US

(21) Appl. No.: 09/418,456

(22) Filed: Oct. 15, 1999

(51) Int. Cl. B01J 23/40

(52) U.S. Cl. 502/326; 502/306; 502/308; 502/314; 502/328; 518/715; 518/717

(57) ABSTRACT

A process for the preparation of a catalyst useful for conducting carbon monoxide hydrogenation reactions, particularly Fischer-Tropsch reactions; the catalyst compositions, use of the catalyst compositions for conducting such reactions, and the products of these reactions. The steps of the process for producing the catalyst comprise mixing together in solution (a) a compound, or salt of a Group VIII metal, e.g., Co(NO₃)₂; (b) a compound, or salt of magnesium, e.g., Mg(NO₃)₂; (c) a compound, salt, or powdered oxide of a Group IVB metal, e.g., zirconia; (d) a refractory inorganic oxide, e.g., kieselguhr; and (e) an ammonium or alkali metal salt precipitating agent, e.g., Na₂CO₃, to produce a precipitated solids mass, or catalyst precursor, and then reducing the precipitated solids mass, or catalyst precursor, to form a catalyst, e.g., (100 Co:6 MgO:10 ZrO₂:200 kieselguhr). The precipitated solids mass, or catalyst precursor, is shaped and brought to a critical level of moisture, and reduced. A catalyst formed from the precursor in this manner has greater activity, and selectivity in the production of high melting waxes in conducting Fischer-Tropsch reactions, and gas make is lower, than in the use of catalysts made conventionally, i.e., from precursors of similar composition at differing moisture levels.

### FIELD OF THE INVENTION

This invention relates to a process for the preparation of novel, highly active catalysts for conducting carbon monoxide hydrogenation reactions, especially Fischer-Tropsch reactions. It also relates to the catalyst, to the process utilizing the catalyst, and to the products of such process; particularly to the production of waxy paraffins of high quality from synthesis gas.

### BACKGROUND

Reactions involving the hydrogenation of CO, e.g., Fischer-Tropsch (F-T) synthesis to produce hydrocarbons, are complex and produce many stages. As a consequence, this necessitates the use of multicomponent, polyfunctional catalysts; catalysts constituted of a supported catalytic metal, or metals, component, e.g., an Iron Group metal such as cobalt, which may be modified or promoted with an additional metal, or metals, e.g., rhenium. (Periodic Table of the Elements, Sargent-Welch Scientific Company; Skokie, Ill. Copyright 1979). Reaction occurs between the feed components, on contact with the catalytic metal, or metals, component and its oxide, reduction of the oxide (which may be reduced only with difficulty), and support component. Knowledge of these reactions is largely empirical, requiring the accumulation and correlation of large amounts of experimental data covering various parameters including not only the composition of the catalyst but also its method of preparation. Trial-and-error methods outstrip theory in the development of catalysts; and these methods are based on more than one hundred years of process developments utilizing catalysts.

Early F-T catalysts were formed by compositing Group VIII or Iron Group metals with kieselguhr, e.g., (100 wt. parts Co per 100 wt. parts kieselguhr), and additionally 20 wt. parts of an oxide of a Group VIIB metal, e.g., Mn, to improve the activity and yield of higher molecular weight hydrocarbons at higher reaction temperature. Further improvements in the development of F-T catalysts resulted in the use of ThO₂ (optimum 18 wt. parts per 100 parts Co) instead of MnO₂, and then to the replacement of part of the ThO₂ by a Group IIA metal oxide, MgO, while doubling the kieselguhr content to produce a commercial form of the catalyst (100:5:8:200).

There then existed a desire to completely exclude ThO₂ from the developed catalyst because of its harmful biological effects, and need to free the ThO₂ for other uses. This resulted in the replacement of the ThO₂ with the oxide of a Group IVB metal, ZrO₂. Thus, ZrO₂ became a promoter for both Co-kieselguhr and Co—MgO-kieselguhr catalysts in the development of F-T catalysts; and, e.g., catalysts constituted of 100 wt. parts Co per 200 wt. parts kieselguhr and 6 ZrO₂+10 MgO promoter, parts by wt. per 100 parts Co, are reported by Eidus and Bulanova at Page 124, Table 15, The Fischer-Tropsch Synthesis by Robert Bernard Anderson 1984 Academic Press, Inc. (1984).

The reported catalyst is prepared by mixing hot solutions of zirconium, cobalt and magnesium nitrates with a precipitating agent, e.g., sodium carbonate, and precipitation of hydrocarbonates of these metals at pH >7 and temperature approximating 100° C. with rapid introduction of the kieselguhr at the time of precipitation, with stirring. The particulate catalyst mass is washed, filtered and shaped. The solids granules are dried, and reduced with hydrogen, e.g., at 400° C. for about 60 minutes. The Co—Mg—ZrO₂-kieselguhr catalyst produced in this manner, contacted and reacted with CO and H₂, produces hydrocarbons. However, the catalyst has considerably less activity than desired, very low selectivity in producing hydrocarbon wax, and gas production is higher than is desirable. Consequently, there is need of a process for producing catalysts of these compositions but which have higher activity and selectivity.

### THE INVENTION

This need and others is achieved in accordance with the present invention which embodies, in preparation of the catalyst, mixing, dispersing, or dissolving in a solution, preferably with heating and stirring, (a) a compound, or salt, of a Group VIII metal, preferably cobalt, (b) a compound, or salt of magnesium, (c) a powdered oxide, compound, or salt of a Group IVB metal, preferably zirconia, (d) a refractory inorganic oxide, preferably kieselguhr, and (e) an ammonium or alkali metal precipitating agent, preferably sodium or potassium carbonate. The precipitated solids mass, or catalyst precursor, is brought to a critical level of moisture, generally by drying, the solids mass is shaped and the metal-containing components thereof then reduced, as by contact with hydrogen or a hydrogen-containing gas. The shaped mass, after reduction, constitutes e.g., a (Group VIII:magnesium oxide:Group IVB oxide:kieselguhr) catalyst, or Group VIII-kieselguhr catalyst, promoted with oxides of magnesium and IVB metals, active for conducting carbon monoxide hydrogenation, preferably F-T reactions.

The Group VIII and magnesium metals are added to the solution as soluble compounds, or salts. The Group IVB metal component can similarly be added to the solution as a soluble compound, or salt, or it may be added to the solution as a powdered oxide, suitably as zirconia. The Group IVB metal may be added during the precipitation step; or added with the refractory inorganic oxide, preferably kieselguhr, suitably in admixture therewith, during the precipitation step. The activity, and selectivity of the catalyst in producing hydrocarbon waxes via F-T synthesis is, after reduction of the catalyst precursor, increased as contrasted with a catalyst of similar composition made from a catalyst precursor of similar composition in an otherwise similar process except that in the latter process the moisture level of the catalyst precursor at the time of reduction is less than about 6 percent, or greater than about 10 percent; based on the weight of the catalyst precursor. During precipitation of the catalyst precursor, the solution is stirred, preferably vigorously and continuously, while the solution is maintained at temperature ranging from about 80° to about 100° C., preferably from about 90° C. to about 100° C., at pH ranging from about 7 to about 9.5, preferably from about 8.0 to about 8.5.

The solids component is precipitated from the solution at low saturation or supersaturation conditions, such conditions being reached by physical or chemical methods, e.g., via evaporation or variation of the pH of the solution. The latter method is generally preferred, the pH of the solution being controlled between about 7 and 9.5, preferably between about 8 and about 8.5, to coprecipitate the cations, or the metal or metals-containing species from solution. Coprecipitation at low supersaturation, at near constant pH, is generally preferred, the conditions of pH most often used being maintained at a value between 7 and 9.5, with temperatures ranging between about 80° C. and about 100° C., preferably about 90° C. and about 100° C. Low supersaturation conditions generally produce precipitates which are more crystalline than precipitates obtained at higher saturation conditions. This is because at the latter condition the rate of nucleation is greater than the rate of crystal growth, a condition which forms a larger number of crystals of smaller particle size. The precipitation of the solids mass is carried out with vigorous stirring, preferably continuous intensive stirring, the solids are separated from the liquid by filtration, and the filter cake then washed sufficient, e.g., to remove the alkali metal and nitrate ions.

The precipitated solids are first washed to remove extraneous matter e.g., alkali metals and nitrate ions; generally with water, at temperatures ranging from ambient to about 100° C., preferably from about 70° C. to about 100° C. The washed solids are then filtered and shaped, i.e., pressed, compacted or extruded to form beads, pills, pellets, powders, extrudates, or material of essentially any desired particulate shape. The shaped material, e.g., an extrudate, is then warmed, or heated in air at temperature ranging from about 100° C. to about 130° C., preferably from about 105° C. to about 110° C., for a period of time sufficient to remove absorbed water in excess of about 10 percent, but not to remove water below about 6 percent, based on the weight of the particulate mass.

It is essential, to achieve the high activity and selectivity of the catalyst in producing high melting hydrocarbon waxes via an F-T reaction, and lowered gas make, that the shaped particulate mass, or catalyst precursor, at the time of its reduction contain water in amount of at least about 6 percent up to about 10 percent, based on the weight of the shaped particulate mass. The shaped catalyst mass on contact with hydrogen or a hydrogen-containing gas is activated, and the activity and selectivity of the catalyst in producing high melting hydrocarbon waxes in an F-T reaction is higher, and gas make is lower, than in the use of a catalyst of similar solids composition produced in a process otherwise similar except that the particulate mass, or catalyst precursor, used to make the catalyst contains less than about 6 percent, or more than about 10 percent water, based on the weight of the shaped catalyst mass.

The catalyst precursor, containing from about 6 percent to about 10 percent water, based on the weight of the particulate mass, is activated for use as a catalyst by contact with hydrogen, or a hydrogen-containing gas, generally at temperature ranging from about 100° C. to about 400° C., preferably from about 300° C. to about 400° C., for a period ranging from about 0.5 hour to about 24 hours.

In its preferred form, soluble compounds or salts of cobalt, magnesium, and zirconium are added in the desired stoichiometric proportions, and dissolved in a liquid, preferably water, to which a solution of a precipitating agent, suitably sodium carbonate is added. A measured amount of a powdered refractory inorganic oxide, preferably powdered kieselguhr, is then added, and after a few minutes if the zirconium has not already been added, the desired stoichiometric amount of powdered zirconia may be added at the temperature and pH given above, with continued stirring while particulate solids are precipitated; or both the powdered kieselguhr and the powdered zirconia are simultaneously added during the precipitation step to produce, after washing, filtering, drying, shaping and reduction with hydrogen, Co:MgO:ZrO₂:kieselguhr catalysts having the following typical and preferred compositions, to wit:

| | | Typical | Preferred |
|---|---|---|---|
| Co, | wt. percent | 5-50 | 20-40 |
| MgO, | wt. percent | 1-10 | 1-5 |
| ZrO₂, | wt. percent | 1-10 | 1-5 |
| kieselguhr, | wt. percent | 30-93 | 50-78 |

The mixture of zirconia and kieselguhr may also be introduced into the heated solution containing the dissolved compounds, or salts of cobalt and magnesium. Then precipitation of the dissolved cobalt and magnesium compounds, or salts, can be carried out by addition of the precipitating agent.

This preparation technique produces a catalyst of increased activity, and selectivity in the production of high melting wax via F-T synthesis with lower gas make.

Hydrocarbon Synthesis

In conducting the preferred Fischer-Tropsch, or F-T synthesis reaction, a mixture of hydrogen and carbon monoxide is reacted over an Iron Group metal catalyst, e.g., a cobalt or ruthenium catalyst, to produce a waxy product which can be separated in various fractions, suitably a heavy or high boiling fraction and a lighter or low boiling fraction, nominally a 700° F.+(372° C.+) reactor wax and a 700° F.−(372° C.−) fraction. The latter, or 700° F.−(372° C.−) fraction, can be separated into (1) a F-T Cold separator liquid, or liquid nominally boiling within a range of about C₅-500° F. (260° C.), and (2) a F-T hot separator liquid, or liquid nominally boiling within a range of about 500° F.−700° F. (260° C.−372° C.). (3) The 700° F.+(272° C.+) stream, with the F-T cold and hot separator liquids, constitute raw materials useful for further processing.

The F-T synthesis process is carried out at temperatures of about 160° C. to about 325° C., preferably from about 190° C. to about 260° C., pressures of about 5 atm to about 100 atm, preferably about 10-40 atm and gas hourly space velocities of from about 300 V/Hr/V to about 20,000 V/Hr/V, preferably from about 500 V/Hr/V to about 15,000 V/Hr/V. The stoichiometric ratio of hydrogen to carbon monoxide in the synthesis gas is about 2.1:1 for the production of higher hydrocarbons. However, the H/CO₂ ratios of 1:1 to about 4:1, preferably about 1.5:1 to about 2.5:1, more preferably about 1.8:1 to about 2.2:1 can be employed. These reaction conditions are well known and a particular set of reaction conditions can be readily determined by those skilled in the art. The reaction may be carried out in virtually any type reactor, e.g., fixed bed, moving bed, fluidized bed, slurry, bubbling bed, etc. The waxy or paraffinic products from the F-T reactor are essentially non-sulfur, non-nitrogen, non-aromatics containing hydrocarbons. This is a liquid product which can be produced and shipped from a remote area to a refinery site for further chemically reacting and upgrading to a variety of products, or produced and upgraded to a variety of products at a refinery site. For example, the hot separator and cold separator liquids, respectively, C₄-C₁₅ hydrocarbons, constitute high quality paraffin solvents which, if desired can be hydrotreated to remove olefin impurities, or employed without hydrotreating to produce a wide variety of wax products. The reactor wax, or C₁₆+ liquid hydrocarbons from the F-T reactor, on the other hand, can be upgraded by various hydroconversion reactions, e.g., hydrocracking, hydroisomerization, catalytic dewaxing, isodewaxing, reforming, etc. or combinations thereof, to produce (i) fuels, i.e., such as stable, environmentally benign, non-toxic mid-distillates, diesel and jet fuels, e.g., low freeze point jet fuel, high cetane jet fuel, etc., (ii) lubes, or lubricants, e.g., lube oil blending components and lube oil base stocks suitable for transportation vehicles, (iii) chemicals and specialty materials, e.g., non-toxic drilling oils suitable for use in drilling muds, technical and medicinal grade white oils, chemical raw materials, monomers, polymers, emulsions, isoparaffinic solvents, and various specialty products.

I. Maximum Distillate

Option A: The reactor wax, or 700° F.+(372° C.+) boiling fraction from the F-T reactor, with hydrogen, is passed directly to a hydroisomerization reactor, HI, operated at the following typical and preferred HI reaction conditions, to wit:

| HI Reactor Conditions | Typical Range | Preferred Range |
|---|---|---|
| Temperature, ° F. (° C.) | 300-800 (148-427) | 550-750 (286-398) |
| Total Pressure, psig | 0-2500 | 300-1200 |
| Hydrogen Treat Rate, | 500-5000 | 2000-4000 |
| SCF/B | | |

While virtually any catalyst useful in hydroisomerization or selective hydrocracking may be satisfactory for this operation, some catalysts perform better than others. For example, catalysts containing a supported Group VIII noble metal, e.g., platinum or palladium, are particularly useful as are catalysts containing one or more Group VIII base metals, e.g., nickel, cobalt, in amounts of about 0.5-20 wt %, which may or may not also include a Group VI metal, e.g., molybdenum, in amounts of about 1-20 wt %. The support for the metals can be any refractory oxide or zeolite or mixtures thereof. Preferred supports include silica, alumina, silica-alumina, silica-alumina phosphates, titania, zirconia, vanadia and other Group III, IV, VA or VI oxides, as well as Y sieves, such as ultrastable Y sieves. Preferred supports include alumina and silica-alumina where the silica concentration of the bulk support is less than about 50 wt %, preferably less than about 35 wt %.

A preferred catalyst has a surface area in the range of about 180-400 m²/gm, preferably 230-350 m²/gm, and a pore volume of 0.3 to 1.0 ml/gm, preferably 0.35 to 0.75 ml/gm, a bulk density of about 0.5-1.0 g/ml, and a side crushing strength of about 0.8 to 3.5 kg/mm.

The preferred catalysts comprise a non-noble Group VIII metal, e.g., iron, nickel, in conjunction with a Group IB metal, e.g., copper, supported on an acidic support. The support is preferably an amorphous silica-alumina where the alumina is present in amounts of less than about 30 wt %, preferably 5-30 wt %, more preferably 10-20 wt %. Also, the support may contain small amounts, e.g., 20-30 wt %, of a binder, e.g., alumina, silica, Group IVA metal oxides, and various types of clays, magnesia, etc., preferably alumina. The catalyst is prepared by coimpregnating the metals from solutions onto the support, drying at 100-150° C., and calcining in air at 200-550° C.

The preparation of amorphous silica-alumina microspheres for supports is described in Ryland, Lloyd B., Tamele, M. W., and Wilson, J. N., Cracking Catalysts, Catalysis: Volume VII, Ed. Paul H. Emmett, Reinhold Publishing Corporation, New York, 1960, pp. 5-9.

The Group VIII metal is present in amounts of about 15 wt % or less, preferably 1-12 wt %, while the Group IB metal is usually present in lesser amounts, e.g., 1:2 to about 1:20 ratio respecting the Group VIII metal. A typical catalyst is shown below:

| | |
|---|---|
| Ni, wt % | 2.5-3.5 |
| Cu, wt % | 0.25-0.35 |
| Al₂O₃-SiO₂ | 65-75 |
| Al₂O₃(binder) | 25-30 |
| Surface Area | 290-355 m²/gm |
| Pour Volume (Hg) | 0.35-0.45 ml/gm |
| Bulk Density | 0.58-0.68 g/ml |

The 700° F.+(372° C.+) conversion to 700° F.−(372° C.−) in the hydroisomerization unit ranges from about 20-80%, preferably 20-50%, more preferably about 30-50%. During hydroisomerization essentially all olefins and oxygen containing materials are hydrogenated.

In a preferred option, both the cold separator liquid, i.e., the C₅-500° (260° C.) boiling fraction, and the hot separator liquid, i.e., the 500° F.-700° F. (260° C.-372° C.) boiling fraction, are hydrotreated in a hydrotreated reactor, H/T, at hydrotreating conditions, the H/T product is combined with the HI product, and passed to a fractionator. The following describes the typical and preferred H/T reaction conditions, to wit:

| H/T Conditions | Typical Range | Preferred Range |
|---|---|---|
| Temperature, ° F. (° C.) | 200-750 (94-398) | 350-600 (175-315) |
| Total Pressure, psig | 100-1500 | 300-750 |
| Hydrogen Treat Rate, | 100-5000 | 500-1500 |
| SCF/B | | |

Suitable hydrotreating catalysts include those which are comprised of at least one Group VIII metal, preferably Fe, Co and Ni, more preferably Co and/or Ni, and most preferably Ni; and at least one Group VI metal, preferably Mo and W, more preferably Mo, on a high surface area support material, preferably alumina. Other suitable hydrotreating catalysts include zeolitic catalysts, as well as noble metal catalysts where the noble metal is selected from Pd and Pt. One, or more than one type of hydrotreating catalyst may be used in the same bed. The Group VIII metal is typically present in an amount ranging from about 2 to 20%, preferably from about 4 to 12%, based on the total weight of the catalyst (wt. %, dry basis). The Group VI metal will typically be present in an amount ranging from about 5 to 50 wt. %, preferably from about 10 to 40 wt. %, and more preferably from about 20 to 30 wt. %.

Gas and C₅-250° F. (121° C.) condensate streams are recovered from the fractionator. After separation and removal of the C₅-250° F. (121° C.) material, a 250° F.−700° F.−(121° C.-372° C.−) diesel fuel or diesel fuel blending component is recovered from the fractionator. A 700° F.+(372° C.+) product component that is recovered is suitable as a lube or lube oil blending component.

The diesel material recovered from the fractionator has the properties shown below:

paraffins at least 95 wt %, preferably at least 96 wt %, more preferably at least 97 wt %, still more preferably at least 98 wt %, and most preferably at least 99 wt %. iso/normal ratio about 0.3 to 3.0, preferably 0.7-2.0; sulfur 50 ppm (wt), preferably nil; nitrogen 50 ppm (wt), preferably 20 ppm, more preferably nil; unsaturates 2 wt %; (olefins and aromatics) oxygenates about 0.001 to less than 0.3 wt % oxygen water-free basis.

The isoparaffins which are present are largely mono methyl branched, and the product contains nil cyclic paraffins, e.g., no cyclohexane.

The 700° F.−(372° C.−) fraction is rich in oxygenates, and e.g., 95% of the oxygenates, are contained in this lighter fraction. Further, the olefin concentration of the lighter fraction is sufficiently low as to make olefin recovery unnecessary; and further treatment of the fraction for olefins is avoided.

These diesel fuels generally have the properties of high cetane number, usually 50 or higher, preferably at least about 60, more preferably at least about 65, lubricity, oxidative stability, and physical properties compatible with diesel pipeline specifications.

The product can be used as a diesel fuel per se or blended with other less desirable petroleum or hydrocarbon containing feeds of about the same boiling range. When used as a blend, the product can be used in relatively minor amounts, e.g., 10% or more for significantly improving the final blended diesel product.

Although, this material will improve almost any diesel product, it is especially useful in blending with refinery diesel streams of low quality. Typical streams are raw or hydrogenated catalytic or thermally cracked distillates and gas oils.

Option B: Optionally, the cold separator liquid and hot separator liquid is not subjected to any hydrotreating. In the absence of hydrotreating of the lighter fractions, the small amount of oxygenates, primarily linear alcohols, in this fraction can be preserved, though oxygenates in the heavier reactor wax fraction are eliminated during the hydroisomerization step. Hydroisomerization serves to increase the amount of isoparaffins in the distillate fuel and helps the fuel to meet pour point and cloud point specifications, although additives may be employed for these purposes.

The oxygen compounds that are believed to promote lubricity may be described as having a hydrogen bonding energy greater than the bonding energy of hydrocarbons (the energy measurements for various compounds are available in standard references); the greater the difference, the greater the lubricity effect. The oxygen compounds also have a lipophilic end and a hydrophilic end to allow wetting of the fuel.

Preferred oxygen compounds, primarily alcohols, have a relatively long chain, i.e., C₁₂+, more preferably C₁₂-C₂₄ primary linear alcohols.

The amount of oxygenates present is rather small, but only a small amount of oxygenates as oxygen on a water free basis is needed to achieve the desired lubricity, i.e., at least about 0.001 wt % oxygen (water free basis), preferably 0.001-0.3 wt % oxygen (water free basis), more preferably 0.0025-0.3 wt % oxygen (water free basis).

Option C: As a further option, all or preferably a portion of the cold separator liquid can be subjected to hydrotreating while the hot separator liquid and the reactor is hydroisomerized; the wider cut hydroisomerization eliminating the fractionator vessel. However, the freeze point of the jet fuel product is compromised to some extent. Preferably, the C₅-350° F. (175° C.) portion of the cold separator liquid is hydrotreated, while the 350° F.+(175° C.+) material is blended with the hot separator liquid and the reactor wax and hydroisomerized. The product of the HI reactor is then blended with the hydrotreated C₅-350° F. (175° C.) product and recovered.

Option D: In a fourth option, a split-feed flow scheme is provided which can produce a jet fuel capable of meeting a jet A-1 freeze point specification. In this option, the hot separator liquid and the reactor wax is hydroisomerized and the product recovered. The cold separator liquid, and optionally any residual 500° F.−(260° C.−) components after subjecting the hot separator liquid and reactor wax to treatment in a wax fractionator prior to hydroisomerization, is subjected to hydrotreating. The hydrotreated product is separated into a (a) C₅-350° F. (175° C.) product which is recovered, and a 350° F.+(175° C.) product which is hydroisomerized and the hydroisomerized product then also recovered. These products can be blended together to form a jet fuel meeting a jet A-1 freeze point specification.

(II) Production of Maximum Diesel

The three streams from the F-T reactor constituting the syncrude, viz. 1) the cold separator liquid (C₅-500° F.), 2) hot separator liquid (500° F.-700° F.), and 3) reactor wax (700° F.+) are each treated in accordance with certain options for producing the maximum amount of a diesel fuel as follows:

Option A: (Single Reaction Vessel: Wax Hydroisomerizer)

The reactor wax from the F-T reactor is passed, with hydrogen, to a wax hydroisomerizer. The other two streams from the F-T reactor, i.e., the cold separator liquid and the hot separator liquid, are combined with the product from the hydroisomerizer, and the total mixture is passed to a fractionation column where it is separated into light gases, naphtha, and a 700° F.−(372° C.−) distillate while a 700° F.+(372° C.+) stream is recycled to extinction in the hydroisomerizer.

The catalysts used to conduct the wax hydroisomerization reaction are described in subsection (I) Maximum Distillate, Option A.

The conditions employed for conducting the wax hydroisomerization reaction are described in subsection (I) Maximum Distillate, Option A.

Option B: (Two Vessel System; Wax Hydroisomerizer and Hydrotreater)

In this Option B, the reactor wax treating scheme described for maximum diesel in accordance with option A is unchanged, but in this instance both the cold separator liquid and hot separator liquid are hydrotreated at hydrotreating conditions, the product therefrom is then mixed with the product of the wax hydroisomerizer, and the total mixture fractionated to recover light gases, naphtha and distillate.

The hydrotreating catalyst used in conducting the hydrogenation reaction is described in subsection (1) Maximum Distillate, Option A.

The conditions employed in conducting the hydrotreating reaction is described in subsection (1) Maximum Distillate, Option A.

Option C: (One Vessel: A Wax Hydroisomerizer)

In accordance with this option, both the cold separator liquid and the reactor wax are hydroisomerized, the hot separator liquid is mixed with the product from the hydroisomerizer, and the total mixture is passed to a fractionater where it is separated into light gases, naphtha and distillate. A 700° F.+(372° C.+) fraction is recycled to extinction in the wax hydroisomerizer.

The catalyst used to conduct the wax hydroisomerization reaction is described in subsection (I) Maximum Distillate, Option A.

The conditions employed in conducting the hydroisomerization reaction is described in subsection (I) Maximum Distillate, Option A.

(III) Production of Maximum Lube

(Two Reaction Vessels; a Hydroisomerizer and a Catalytic Dewaxing Unit)

The reactor wax, or 700° F.+ boiling fraction, and the hot separator liquid, or 500° F.-700° F. boiling fraction, from the F-T reactor are reacted in a hydroisomerizer and the product therefrom passed to a fractionator column wherein it is split into C₁-C₄ gases, naphtha, distillate and a 700° F.+ fraction.

The 700° F.+ fraction is dewaxed, preferably in a catalytic dewaxing unit, or is both catalytically dewaxed and the product then subjected to a low vacuum distillation, or fractionation, to produce a lubricant, or lubricants. The lubricant, or lubricants, is of high viscosity index and low pour point, and is recovered in high yield.

In conducting the hydroisomerization step, the feed, at least 50 percent, more preferably at least 70 percent, of which boils above 700° F., with hydrogen, is contacted and hydroisomerized over a hydroisomerization catalyst at hydroisomerization conditions sufficient to convert from about 20 percent to about 50 percent, preferably from about 30 to about 40 percent, of the 700° F.+ hydrocarbons of the feed to 700° F.− products, based on the weight of the total feed. At these conversion levels, major amounts of the n-paraffins are hydroisomerized, or converted to isoparaffins, with minimal hydrocracking to gas and fuel by-products.

The total feed to the hydroisomerization reactor, which constitutes from about 20 percent to about 90 percent, preferably from about 30 percent to about 70 percent, by weight of the total liquid output from the F-T reactor, is fed, with hydrogen, into the hydroisomerization reactor. The hydroisomerization reactor contains a bed of hydroisomerization catalyst with which the feed and hydrogen are contacted; the catalyst comprising a metal hydrogenation or dehydrogenation component composited with an acidic oxide carrier, or support. In the hydroisomerization reactor, the feed introduced thereto is thus converted to isoparaffins and lower molecular weight species via hydroisomerization.

The hydrogenation or dehydrogenation metal component of the catalyst used in the hydroisomerization reactor may be any Group VIII metal of the Periodic Table of the Elements. Preferably the metal is a non-noble metal such as cobalt or nickel; with the preferred metal being cobalt. The catalytically active metal may be present in the catalyst together with one or more metal promoters or co-catalysts. The promoters may be present as metals or as metal oxides, depending upon the particular promoter. Suitable metal oxide promoters include oxides of metals from Group VI of the Periodic Table of the Elements. Preferably, the catalyst contains cobalt and molybdenum. The catalyst may also contain a hydrocracking suppressant since suppression of the cracking reaction is necessary. The hydrocracking suppressant may be either a Group IB metal or a source of sulfur, usually in the form of a sulfided catalytically active metal, or a Group IB metal and a source of sulfur.

The acidic oxide carrier component of the hydroisomerization catalyst can be furnished by a support with which the catalytic metal or metals can be composited by well known methods. The support can be any acidic oxide or mixture of oxides or zeolites or mixtures thereof. Preferred supports include silica, alumina, silica-alumina, silica-alumina-phosphates, titania, zirconia, vanadia and other Group III, IV, V or VI oxides, as well as Y sieves, such as ultra stable Y sieves. Preferred supports include alumina and silica-alumina, more preferably silica-alumina where the silica concentration of the bulk support is less than about 50 wt. %, preferably less than about 35 wt. %. Most preferably the concentration ranges from about 15 wt. % to about 30 wt. %. When alumina is used as the support, small amounts of chlorine or fluorine may be incorporated into the support to provide the acid functionality.

A preferred supported catalyst is one having surface areas in the range of about 180 to about 400 m²/gm, preferably about 230 to about 350 m²/gm, and a pore volume of about 0.3 to about 1.0 mL/gm, preferably about 0.35 to about 0.75 mL/gm, a bulk density of about 0.5 to about 1.0 g/mL, and a side crushing strength of about 0.8 to about 3.5 kg/mm.

The preparation of preferred amorphous silica-alumina micropheres for use as supports is described in Ryland, Lloyd B., Tamele, M. W., and Wilson, J. N., Cracking Catalysts, Catalysis; Volume VII, Ed. Paul H. Emmett, Reinhold Publishing Corporation, New York, 1960.

The hydroisomerization reactor is operated at conditions defined as follows:

| Major Operating Variables | Typical | Preferred |
|---|---|---|
| Temperature, ° C. | 200-450 | 290-400 |
| Pressure, psig | 300-10,000 | 500-1500 |
| Hydrogen Treat Rate, SCF/B | 500-5000 | 1000-4000 |

During hydroisomerization, the amount of conversion of the 700° F.+ to 700° F.− is critical, and ranges from about 20 percent to about 50 percent, preferably from about 30 to about 40 percent; and at these conditions essentially all olefins and oxygenated products are hydrogenated.

The 700° F.+ fraction from the bottom of the fractionation column is passed to a catalytic dewaxing unit wherein the waxy lubricant molecules are subjected to a pour point reducing step to produce final or near-final lubricants; some of which may require further separation in a lube vacuum pipe still. Thus, a lubricant from the catalyst dewaxing unit can be passed to a low vacuum pipe still for further concentration of lube molecules into a final product.

The final pour point reducing step in the catalyst dewaxing unit is preferably carried out by contact with a unitized mixed powder pellet catalyst comprising a dehydrogenation component, a dewaxing component, and an isomerization component. The dehydrogenation component is a catalytically active metal, or metals, comprising a Group VIB, VIIB or Group VIII metal of the Periodic Table of the Elements. The dewaxing component is comprised of an intermediate or small pore crystalline zeolite, and the isomerization component is constituted of an amorphous acidic material. Such catalyst not only produces lubricants with high viscosity indexes and significantly reduced pour points but reduced yields of undesirable gas and naphtha.

Catalytic dewaxing is a process well documented in the literature; as are catalysts useful in such processes. However, the preferred catalysts employed in the catalytic dewaxing unit are unitized mixed powder pellet catalysts characterized as particulate solids particles made by mixing together a powdered molecular sieve dewaxing component and a powdered amorphous isomerization component, one or both components of which, preferably both, contains a dehydrogenation component, or components, (or to which is subsequently added a dehydrogenation component, or components), forming a homogeneous mass from the mixture, and pelletizing the mass to produce solids particles, or pellets, each of which contains the dewaxing component, the isomerization component, and the dehydrogenation component in intimate admixture; or contains the dewaxing component and the isomerization component to which is added the dehydroisomerization component, or components, to form particulate solids wherein the dewaxing component, the isomerizing component, and hydrogenation components are present in intimate mixture. The components of the catalyst work together, cooperatively and synergistically, to selectively crack and convert the n-paraffins, or waxy components of the feed, to produce reaction products which are removed from the process as gas, while allowing branched hydrocarbons to pass downstream for removal as useful lube oil blending components, and lube oil products. This catalyst permits the conversion of Fischer-Tropsch reaction products to upgraded products from which lubricants of high viscosity index and low pour point can be recovered. This objective, and others, is achieved while minimizing the production of the less desirable gas and naphtha.

In preparation of the unitized powder pellet catalyst, the catalytic metal, or metals, dehydrogenation component can be composited with the dewaxing component, or the catalyst metal, or metals, dehydrogenation component can be composited with the isomerization component, or the catalytic metal, or metals, dehydrogenation component can be composited with both the dewaxing and the isomerization components prior to formation of the unitized powder pellet catalyst. The unitized powder pellet catalyst can also be formed from a composite of the dewaxing and isomerization components and a catalytic metal, or metals, dehydrogenation component can then be deposited thereon. Suitably, the dehydrogenation component is a Group VIB, Group VIIB, or Group VIII metal, or metals, preferably a Group VIII noble metal, or metals, of the Periodic Table of the Elements (Sargent-Welch Scientific Company: Copyright 1968), suitably ruthenium, rhodium, palladium, osmium, iridium and platinum. Suitably, the catalytic metal, or metals, dehydrogenation component is present in concentration ranging from about 0.1 percent to about 5.0 percent, preferably from about 0.1 percent to about 3.0 percent, based on the weight of the total catalyst (dry basis). In general, the molecular sieve component is present in the catalyst in concentrations ranging from about 2 percent to about 80 percent, preferably from about 20 percent to about 60 percent, based on the weight of the catalyst (dry basis). The isomerization component is generally present in concentration ranging from about 20 percent to about 75 percent, preferably from about 30 percent to about 65 percent, based on the weight of the catalyst (dry basis).

The dewaxing component of the unitized powder pellet catalyst is preferably an intermediate pore, or a small pore size molecular sieve, or zeolite. A preferred molecular sieve dewaxing component is an intermediate pore size zeolite having a 10 membered ring unidirectional pore material which has oval 1-D pores having a minor axis between 4.2 Å and 4.8 Å and a major axis between 5.4 Å and 7.0 Å as determined by X-ray crystallography.

A yet more preferred dewaxing component used to form the unitized powder pellet catalyst is characterized as a small pore molecular sieve wherein the pore windows are formed by 8 oxide atoms that form the limiting edge of this pore window. The oxide atoms each constitute one of the four oxide atoms of a tetrahedrally coordinated cluster around a silicon or aluminum ion, called a framework ion or atom. Each oxide ion is coordinated to two framework ions in these structures. The structure is referred to as “8 ring” as a shorthand way of describing a more complex structure; a shorthand notation used extensively in describing molecular sieves of this type is the Atlas Of Zeolite Structure Types, Fourth Revised Edition 1996 in 8 Zeolites 17:1-230, 1996. Pores of this size are such as to substantially exclude molecules of larger size than normal hexane; or, conversely, to allow entry into the pores of molecules of smaller size than normal hexane. The small pore molecular sieve is of pore size ranging between about 6.3 Å and 2.3 Å, preferably about 5.1 Å to about 3.4 Å, and comprised of a crystalline tetrahedral framework oxide component. It is preferably selected from the group consisting of zeolites, tectosilicates, tetrahedral aluminophosphates and tetrahedral silicoaluminophosphates (SAPOs). Exemplary of the molecular sieve components of this type are SAPO-56, (AFX), ZK-5 (KF1), AlPO₄-25 (ATV), Chabazite (CHA), TMA-E (EAB), Erionite (ERI), and Linde Type A (LTA). The Linde Type A zeolite is a particularly preferred molecular sieve.

The catalysts, besides the dewaxing, isomerization, and dehydrogenated components, may optionally also contain binder materials. Exemplary of such binder materials are silica, alumina, silica-alumina, clays, magnesia, titania, zirconia or mixtures of these with each other or with other materials. Silica and alumina are preferred, with alumina being the most preferred binder. The binder, when present, is generally present in amount ranging from about 5 percent to about 50 percent, preferably from about 20 percent to about 30 percent, based on the weight of the total catalyst (dry basis; wt. %).

The unitized catalyst can be prepared by pulverizing and powdering and then mixing together a powdered finished molecular sieve catalyst and a powdered finished isomerization catalyst, as components, and then compressing the homogeneous mass to form particulate solid shapes, e.g., lumpy solid shapes, extrudates, beads, pellets, pills, tablets or the like; each solid shape of which contains the molecular sieve dewaxing component, the isomerization component and the dehydrogenation component. One or more catalysts of given type can be pulverized and powdered, and mixed to provide a necessary component, or components, of the unitized mixed pellet catalyst. For example, a molecular sieve catalyst can supply the dewaxing and dehydrogenating functions, to wit: a molecular sieve component composited with, preferably by impregnation, a Group VIII metal, or metals, of the Periodic Table, most preferably a Group VIII noble metal, or metals, e.g., platinum or palladium. Generally, the catalyst is impregnated with from about 0.1 percent to about 5.0 percent, preferably from about 0.1 percent to about 3.0 percent, based on the weight of the catalytic component (wt. %; dry basis).

The isomerization and dehydrogenation function, on the other hand, can be supplied by an isomerization catalyst. Thus, the isomerization component of the catalyst is comprised of an amorphous acidic material; an isomerization catalyst comprised of an acidic support composited with a catalytically active metal, preferably a Group VIII noble metal of the Periodic Table, suitably ruthenium, rhodium, palladium, osmium, iridium and platinum which can supply the isomerization and dehydrogenation functions. The isomerization catalyst component can thus be an isomerization catalyst such as those comprising a refractory metal oxide support base (e.g., alumina, silica-alumina, zirconia, titanium, etc.) on which is deposited a catalytically active metal selected from the group consisting of Group VIB, Group VIIB, Group VIII metals and mixtures thereof, preferably Group VIII metals, more preferably noble Group VIII metals, most preferably platinum or palladium and optionally including a promoter or dopant such as halogen, phosphorus, boron, yttria, magnesia, etc. preferably halogen, yttria or magnesia, most preferably fluorine. The catalytically active metals are present in the range of from about 0.1 to about 5.0 wt. %, preferably from about 0.1 to about 2.0 wt. %. The promoters and dopants are used to control the acidity of the isomerization catalyst. Thus, when the isomerization catalyst employs a base material such as alumina, acidity is imparted to the resultant catalyst by addition of a halogen, preferably fluorine. When a halogen is used, preferably fluorine, it is present in an amount in the range of about 0.1 to about 10 wt. %, preferably about 0.1 to about 3 wt. %, more preferably from about 0.1 to about 2 wt. % most preferably from about 0.5 to about 1.5 wt. %. Similarly, if silica-alumina is used as the base material, acidity can be controlled by adjusting the ratio of silica to alumina or by adding a dopant such as yttria or magnesia which reduces the acidity of the silica-alumina base material as taught in U.S. Pat. No. 5,254,518 (Soled, McVicker, Gates, Miseo). One or more isomerization catalysts can be pulverized and powdered, and mixed to provide two of the necessary components of the unitized mixed pellet catalyst.

Dewaxing is preferably carried out in the catalyst dewaxing unit in a slurry phase, or phase wherein the catalyst is dispersed throughout and movable within a liquid paraffinic hydrocarbon oil. The 700° F.+ feed is passed, with hydrogen, into the catalyst dewaxing unit and reaction carried out at catalytic dewaxing conditions tabulated as follows:

| Major Operating Variables | Typical | Preferred |
|---|---|---|
| Temperature, ° F. (° C.) | 300-840 (148-448) | 500-752 (260-400) |
| Pressure, psig | 300-10,000 | 500-1500 |
| Hydrogen Treat Rate, | 500-5000 | 1000-4000 |
| SCF/B | | |

The product of the catalyst dewaxing unit is generally a fully converted dewaxed lube oil blending component, or lube oil having viscosity indexes ranging above about 110, and lube pour point below about −15° C.

The invention, and its principle of operation will be better understood by reference to the following examples which illustrate specific and preferred embodiments. All parts are in terms of weight units except as otherwise specified.

### EXAMPLES

A series of activated, reduced catalysts were prepared via several techniques described below, as Methods A, B, C and D, respectively. Each of the finished catalysts, dry basis, were of similar composition, i.e., 22.1 wt. % Co, 1.3 wt. % MgO and 2.6 wt. % ZrO₂, composited with 74.0 wt. % of an SiO₂ solids (kieselguhr) support.

Preparation of Catalyst Precursors

Method A:

A first solution was prepared with 30.00 gms of Co(NO₃)₂*6H₂O in distilled water to a volume of 150 ml. A second solution was prepared with 20 gm Na₂CO₃ in distilled water to give a total second solution volume of 200 ml. Kieselguhr was prepared by calcining in air for 4-5 hours at 450° C. The first and second solutions were heated to 95-100° C. The second solution was added rapidly to the first with vigorous stirring. Stirring of the mixture was continued for 5-6 minutes after completing addition of the second solution. After the 5-6 minute stirring period, of the mixture pH was measured. The pH was 8.1 to 8.4. Then 20.36 gm of the calcined kieselguhr and 0.72 gm of ZrO₂ were added to the mixture and stirring continued for 1-2 minutes. The catalyst precursor was recovered by filtering the mixture in a Buchner funnel. The catalyst precursor was washed with 7-8 liters of hot (85-90° C.) water. Completion of washing was determined by titrating 100 ml of wash water with 0.1 N H₂SO₄ to a methyl orange endpoint. Washing was complete if less than 3-5 ml of acid is required for the titration. If more acid was needed, washing was continued with hot (80-100° C.) water until a satisfactory titration was obtained. After washing, the catalyst precursor was formed into 3 mm diameter by 4 mm long cylinders by extrusion, forming a catalyst precursor extrudate.

Method B:

Solutions were prepared, and a portion of kieselguhr calcined as described in Method A. The second solution, containing 20 gm Na₂CO₃, was then added to the first solution at room temperature with vigorous stirring, the mixture then heated to 95-100° C., and the mixture then stirred for an additional 5-6 minutes after completing addition of the second solution. As in Method A, at this time the pH was 8.1 to 8.4. The calcined kieselguhr and ZrO₂ were then added to the solution, and formation of the catalyst precursor extrudate completed as described in Method A.

Method C:

In accordance with this method, a first solution was prepared with 30.00 gm of Co(NO₃)₂*6H₂O, 2.28 gm of Mg(NO₃)₂*6H₂O, and 1.87 gm ZrOCl₂*8H₂O in 150 ml of distilled water. Kieselguhr was prepared in similar amount and calcined as described in Methods A and B, as was the second solution which contained the Na₂CO₃ precipitating agent. Both solutions were separately heated to 95-100° C., and the second solution added to the first with vigorous stirring; stirring being continued for 5-6 minutes after addition of the second solution. The kieselguhr was then added, at which point the pH measured 8.1. The catalyst precursor was then filtered, washed, and an extrudate recovered as described by Method A.

Method D:

The procedure employed in accordance with this method is essentially as described in Method C except that the first solution, besides 30.00 gm of Co(NO₃)₂*6H₂O and 2.28 gm of Mg(NO₃)₂*6H₂O, contained 1.34 gm of ZrO(NO₃)₂. The kieselguhr was similarly prepared and calcined, as was the Na₂CO₃, or second solution, and both similarly added to the first solution to precipitate the precursor. The catalyst precursor was filtered, washed, and recovered as an extrudate as described in accordance with Method C.

Drying of Catalyst Precursors

Portions of the washed extrudates formed in accordance with the Methods A, B, C and D, respectively, were dried in a drying oven in air for varying times at 105-110° C. to prepare catalyst precursor extrudates of varying residual moisture contents. Actual drying times varied from 65 to 170 minutes. The residual moisture content in a catalyst precursor extrudate was determined by taking a sample of the dried extrudate and further drying this sample in an oven in air at 105-110° C. until constant weight was obtained, i.e., until no further weight change occurred with increasing drying time. The difference between the initial weight of this sample and its constant weight was used to calculate the residual moisture content of the catalyst precursor extrudate.

Reduction of Catalyst Precursor

Fifty ml portions of catalyst precursor extrudates from stock made via Methods A, B, C and D, respectively, were placed in a horizontal quartz tube. Hydrogen was passed through each tube to displace air and then the tube was placed into an oven preheated to 370-400° C. Hydrogen flow rate was adjusted to 5-8 liters/hr. In 20-30 minutes, the catalyst temperature increased to 370-390° C. Then the hydrogen flow was increased to 150 liters/hr., giving a hydrogen gas hourly space velocity (GHSV) of 3000/hr. The catalyst was held at this condition for 20-35 minutes. Then the hydrogen flow was decreased to 5-8 liters/hr. and the tube containing the catalyst was removed from the oven to cool. The hydrogen flow was continued at 5-8 liters/hr. while the catalyst cooled. After the catalyst had cooled, the tube was purged with CO₂. Then the catalyst was loaded into a reactor under CO₂.

Preconditioning of Catalyst

Each of the 50 ml portions of reduced catalyst was next preconditioned for use in conducting hydrocarbon synthesis runs by placement in a reactor under CO₂. The reactor was closed and purged with 2:1H₂:CO at room temperature. The H₂:CO flow was adjusted to give a GHSV of 50-80/hr. The reactor pressure was adjusted to nominally atmospheric pressure. The temperature of the reactor was then increased rapidly from room temperature to 100° C. Then the temperature was increased from 100° C. to 160° C. at 3-5° C. per hour. At 160° C. the GHSV was adjusted to 80/hr. The temperature was then increased stepwise 2° C. every 8 hours until a gas contraction of 45% was achieved. When the contraction was 45%, the temperature was decreased to 160° C., the GHSV was decreased to 50/hr, and the reactor pressure was increased to 9-10 atm. Then the temperature was increased stepwise 2° C. every 8 hours until the gas contraction was 50%. This condition was held for 24 hours. The space velocity was then increased to 100/hr. This condition was held for 8 hours. Then the temperature was increased 2° C. every 8 hours until contraction was 53-58%. After the contraction reached 53-58%, all parameters were held constant for one week.

Tests in Hydrocarbon Synthesis Reactor

After catalyst preconditioning, the reactor temperature was adjusted to 170-174° C., the GHSV to 100/hr., and the pressure to 9 atm. These conditions were held constant for 10 days. After the 10 day test period, a total material balance was made to determine catalyst performance. Table 1 shows the results of the catalyst testing. The catalyst precursor extrudates are grouped in terms of residual moisture ranges and there is given an average of the results within each range. This is shown in Table 2. An observation was that catalyst precursors with low residual moisture content have a grey color as opposed to the violet color exhibited by precursors of higher residual moisture content. This signifies a change in structure of the precursor when moisture is removed.

TABLE 1
Catalyst Testing Results

| Catalyst | | | | | |
|---|---|---|---|---|---|
| Precursor | | | | | |
| Method | Preparation | Co. | MgO, | ZrO₂, | Moisture |
| Extrudate | Zr Source | Wt. % | Wt. % | Wt. % | Wt. % |
| 1A | ZrO₂ | 20.6 | 1.1 | 2.3 | 10 |
| 2B | ZrO₂ | 24.0 | 1.3 | 2.8 | 5 |
| 3B | ZrO₂ | 22.1 | 1.1 | 2.9 | 10 |
| 4A | ZrO₂ | 22.1 | 1.5 | 2.6 | 11.7 |
| 5B | ZrO₂ | 21.9 | 1.4 | 2.7 | 10 |
| 6B | ZrO₂ | 23.3 | 1.0 | 2.8 | 6 |
| 7A | ZrO₂ | 22.3 | 1.5 | 2.5 | 6 |
| 8B | ZrO₂ | 21.4 | 1.5 | 2.6 | 11 |
| 9B | ZrO₂ | 22.9 | 1.2 | 2.7 | 10 |
| 10A | ZrO₂ | 23.6 | 1.1 | 2.8 | 7 |
| 11A | ZrO₂ | 22.9 | 1.1 | 2.7 | 10 |
| 12A | ZrO₂ | 22.7 | 1.4 | 2.9 | 6 |
| 13A | ZrO₂ | 23.3 | 1.5 | 2.6 | 10 |
| 14A | ZrO₂ | 23.8 | 1.5 | 2.7 | 9.5 |
| 15A | ZrO₂ | 20.6 | 1.3 | 2.4 | 12 |
| 16A | ZrO₂ | 22.1 | 1.3 | 2.6 | 11 |
| 17A | ZrO₂ | 22.0 | 1.3 | 2.6 | 10.9 |
| 18A | ZrO₂ | 21.0 | 1.1 | 2.4 | 11 |
| 19A | ZrO₂ | 21.0 | 1.1 | 2.4 | 11.5 |
| 20A | ZrO₂ | 20.6 | 1.1 | 2.6 | 11 |
| 21C | ZrOCl₂ | 22.1 | 1.3 | 2.7 | 11.8 |
| 22C | ZrOCl₂ | 19.5 | 1.1 | 2.6 | 6.5 |
| 23D | ZrO(NO₃)₂ | 22.5 | 1.2 | 2.3 | 8.5 |
| | | | | | Wax |
| | | | | | Yield⁽²⁾, |
| Catalyst | | | | | gm/cu m |
| Precursor | | Reaction | Contract- | C₅+ | (100° C. |
| Method | Preparation | Temp, | tion⁽¹⁾, | Yield⁽²⁾, | Drop |
| Extrudate | Zr Source | ° C. | (%) | gm/cu m | Point) |
| 1A | ZrO₂ | 174 | 56 | 52 | 11.9 |
| 2B | ZrO₂ | 174 | 46 | 36 | 0 |
| 3B | ZrO₂ | 174 | 60 | 81 | 11.4 |
| 4A | ZrO₂ | 174 | 50 | 57 | 16.5 |
| 5B | ZrO₂ | 174 | 57 | 67 | 28.7 |
| 6B | ZrO₂ | 174 | 50 | 66 | 26 |
| 7A | ZrO₂ | 174 | 47 | 53 | 12 |
| 8B | ZrO₂ | 170 | 57 | 81 | 26.4 |
| 9B | ZrO₂ | 170 | 55 | 71 | 36.6 |
| 10A | ZrO₂ | 170 | 32 | 38 | 22 |
| 11A | ZrO₂ | 172 | 58 | 88 | 26.3 |
| 12A | ZrO₂ | 172 | 57 | 67 | 24.6 |
| 13A | ZrO₂ | 172 | 55 | 65 | 26.9 |
| 14A | ZrO₂ | 172 | 56 | 74 | 24.7 |
| 15A | ZrO₂ | 173 | 38 | 39 | 7.8 |
| 16A | ZrO₂ | 173 | 55 | 71 | 20.4 |
| 17A | ZrO₂ | 173 | 53 | 64 | 15.1 |
| 18A | ZrO₂ | 174 | 61 | 87 | 30.7 |
| 19A | ZrO₂ | 174 | 54 | 71 | 26.9 |
| 20A | ZrO₂ | 174 | 54 | 76 | 32.9 |
| 21C | ZrOCl₂ | 170 | 54 | 65 | 25.9 |
| 22C | ZrOCl₂ | 170 | 34 | 38 | 6.4 |
| 23D | ZrO(NO₃)₂ | 170 | 54 | 81 | 25.6 |

⁽¹⁾Contraction-reduction in volume of feed gas caused by reaction over catalyst
⁽²⁾C₅+ or Wax Yield-measured in grams of product per cubic meter of feed gas at standard temperature and pressure

TABLE 2
Grouped and Averaged Catalyst Testing Results

| | | | | | | | | Wax Yield, |
|---|---|---|---|---|---|---|---|---|
| Moisture | | | | Average | | | C₅ + | gm/cu m |
| Range, | | | | Moisture, | Reaction | Contraction, | Yield, | (100° C. |
| Wt. % | Co | MgO | ZrO₂ | Wt. % | Temp, ° C. | (%) | gm/cu m | Drop Point) |
| <8 | 22.6 | 1.2 | 2.7 | 6.1 | 172.3 | 44.3 | 49.7 | 15.2 |
| 8-10 | 22.5 | 1.3 | 2.6 | 9.8 | 172.3 | 56.4 | 72.4 | 24.0 |
| >10 | 21.4 | 1.3 | 2.5 | 11.3 | 172.8 | 52.9 | 67.9 | 22.5 |

From these data, it is clear that catalysts of maximum activity (as measured by gas contraction), C₅+ liquid yield, and wax yield can be obtained for use in hydrocarbon synthesis operations by control of the moisture content during the preparation of the catalyst precursor. Catalyst activity, as measured by gas contraction, for catalysts made from catalyst precursor extrudates of moisture level of about 6.0 wt. % begins to increase and continues with catalysts made from specimens of water content above about 10.0 wt. %, at which time the activity begins to drop. The C₅+ liquid yield for catalysts made from catalyst precursor extrudates with moisture content above about 6.0 wt. % shows an even more rapid rate of increase, declining only with catalysts made from specimens of water content above about 10.0 wt. %. The same effect is seen for wax yield for use of catalysts made from precursors having a moisture level ranging from about 6 wt. % to above about 10.0 wt. %

The hydrocarbons produced by a hydrocarbon synthesis process according to the invention are typically upgraded to more valuable products, by subjecting all or a portion of the C5+ hydrocarbons to fractionation and/or conversion. By conversion is meant one or more operations in which the molecular structure of at least a portion of the hydrocarbon is changed and includes both noncatalytic processing (e.g., steam cracking), and catalytic processing (e.g., catalytic cracking) in which a fraction is contacted with a suitable catalyst. If hydrogen is present as a reactant, such process steps are typically referred to as hydroconversion and include, for example, hydroisomerization, hydrocracking, hydrodewaxing, hydrorefining and the more severe hydrorefining referred to as hydrotreating, all conducted at conditions well known in the literature for hydroconversion of hydrocarbon feeds, including hydrocarbon feeds rich in paraffins. Illustrative, but nonlimiting examples of more valuable products formed by conversion include one or more of a synthetic crude oil, liquid fuel, olefins, solvents, lubricating, industrial or medicinal oil, waxy hydrocarbons, nitrogen and oxygen containing compounds, and the like. Liquid fuel includes one or more of motor gasoline, diesel fuel, jet fuel, and kerosene, while lubricating oil includes, for example, automotive, jet, turbine and metal working oils. Industrial oil includes well drilling fluids, agricultural oils, heat transfer fluids and the like.

It is understood that various other embodiments and modifications in the practice of the invention will be apparent to, and can be readily made by, those skilled in the art without departing from the scope and spirit of the invention described above. Accordingly, it is not intended that the scope of the claims appended hereto be limited to the exact description set forth above, but rather that the claims be construed as encompassing all of the features of patentable novelty which reside in the present invention, including all the features and embodiments which would be treated as equivalents thereof by those skilled in the art to which the invention pertains.

Having described the invention, what is claimed is:

1. A process for the preparation of a catalyst useful for conducting carbon monoxide hydrogenation reactions which comprises
mixing together, dispersing, or dissolving in solution
a) a compound, or salt of a Group VIII metal,
b) a compound, or salt of magnesium,
c) a powdered oxide, compound, or salt of a Group IVB metal,
d) a refractory inorganic oxide, and
e) an ammonium or alkali salt precipitating agent
to produce a precipitated solids precursor,
shaping the precipitated solids precursor,
drying the shaped precipitated solids precursor sufficient to bring the moisture content thereof to a level ranging from about 6 percent to about 10 percent, based on the weight of the precipitated solids precursor, and then
reducing the shaped precipitated solids precursor to produce, and activate a catalyst, the activity and selectivity of which in producing high melting hydrocarbon waxes via a Fischer-Tropsch reaction is increased, and gas production is lowered, as contrasted with a catalyst of similar composition produced from a precipitated solids precursor in a process otherwise similar except that the moisture level concentration of the precursor at the time of reduction is less than about 6 percent or greater than about 10 percent, based on the weight of the precipitated solids precursor.

2. The process of claim 1 wherein the solids precursor is precipitated from the solution at pH ranging from about 7 to about 9.5 with vigorous stirring at temperature ranging from about 80° C. to about 100° C.

3. The process of claim 2 wherein the solids precursor is precipitated from the solution at low saturation or supersaturation conditions, the pH of the solution is maintained at from about 8 to about 8.5, and at temperatures ranging from about 90° C. to about 100° C.

4. The process of claim 1 wherein the solids precursor precipitated from solution is filtered, washed, shaped to form beads, pills, pellets, powders, extrudates or other shape of the expressed moisture content, and the shaped particles then reduced by contact with hydrogen or a hydrogen-containing gas to form and activate the catalyst.

5. The process of claim 1 wherein the Group VIII metal is cobalt.

6. The process of claim 1 wherein the Group VIII metal is cobalt, the Group IVB metal is zirconium, the refractory inorganic oxide is kieselguhr, and the solids precursor is precipitated from the solution at pH ranging from about 7 to about 9.5.

7. The process of claim 6 wherein the solids precursor is precipitated from the solution at low saturation or supersaturation conditions, the pH of the solution is maintained at from about 8 to about 8.5, and at temperatures ranging from about 90° C. to about 100° C.

8. The process of claim 6 wherein the solids precursor precipitated from solution is filtered, washed, shaped to form beads, pills, pellets, powders, extrudates or other shape of the expressed moisture content, and the shaped particles then reduced by contact with hydrogen or a hydrogen-containing gas to form and activate the catalyst.

9. The process of claim 1 wherein the Group VIII metal is cobalt, the Group IVB metal is zirconium, the refractory inorganic oxide is kieselguhr, the solids precursor is precipitated from the solution at pH ranging from about 7 to about 9.5, and the precipitated solids precursor is reduced by contact with hydrogen or hydrogen-containing gas to produce a Co—MgO—ZrO₂—kieselguhr having the following composition, to wit:

| | | |
|---|---|---|
| Co, | wt. percent | 5-50 |
| MgO, | wt. percent | 1-10 |
| ZrO₂, | wt. percent | 1-10 |
| kieselguhr, | wt. percent | 30-93 |

10. The process of claim 9 wherein the Co—MgO—ZrO₂—kieselguhr catalyst has the following composition, to wit:

| | | |
|---|---|---|
| Co, | wt. percent | 20-50 |
| MgO, | wt. percent | 1-5 |
| ZrO₂, | wt. percent | 1-5 |
| kieselguhr, | wt. percent | 50-78 |

11. A catalyst comprising a powder, or particulate solids support, and a metal, or oxide of a metal, or metals, catalytically active useful for conducting carbon monoxide hydrogenation reactions made in a process, the steps of which are characterized by any of claims 1 through 10.

12. A process useful for conducting carbon monoxide hydrogenation reactions by contact at reaction conditions with a catalyst comprising a powder, or particulate solids support, and a metal, or oxide of a metal, or metals, catalytically active for conducting carbon monoxide hydrogenation reactions made by the catalyst preparation steps characterized by any of claims 1 through 10.

13. A process wherein C₅+ hydrocarbons are produced from carbon monoxide and hydrogen by contact at reaction conditions with a catalyst comprising a powder, or particulate solids support, and an oxide, or oxides, of a metal, or metals, catalytically active for conducting carbon monoxide hydrogenation reactions made by the steps comprising a process as characterized by any of claims 1 through 10, and all or a portion of the C₅+ hydrocarbons produced by said process are upgraded to more valuable products by fractionation and/or a conversion operation.

14. A product comprising a hydrocarbon obtained by converting a mixture of hydrogen and carbon monoxide via a carbon monoxide hydrogenation reaction by contact, at reaction conditions, with a catalyst comprising a powder, or particulate solids support, and a metal, or metals, catalytically active for conducting said carbon monoxide hydrogenation reactions, made by the steps of a process characterized by any of claims 1 through 10.

15. A C₅+ hydrocarbon product obtained by converting a mixture of hydrogen and carbon monoxide via a carbon monoxide hydrogenation reaction by contact, at reaction conditions, with a catalyst comprising a powder, or particulate solids support, and a metal, or metals, catalytically active for conducting said carbon monoxide hydrogenation reactions, made by the steps of a process characterized by any of claims 1 through 10.

16. A hydrocarbon distillate product suitable for use as a transportation fuel which is produced by upgrading a hydrocarbon product obtained by converting a mixture of hydrogen and carbon monoxide via a carbon monoxide hydrogenation reaction by contact, at reaction conditions, with a catalyst comprising a powder, or particulate solids support, and a metal, or metals, catalytically active for conducting said carbon monoxide hydrogenation reactions, made by the steps of a process characterized by any of claims 1 through 10.

17. A lube oil, lube oil blending component, or lube oil base stock which is produced by upgrading a hydrocarbon product obtained by converting a mixture of hydrogen and carbon monoxide via a carbon monoxide hydrogenation reaction by contact, at reaction conditions, with a catalyst comprising a powder, or particulate solids support, and a metal, or metals, catalytically active for conducting said carbon monoxide hydrogenation reactions, made by the steps of a process characterized by any of claims 1 through 10.

18. A C₅+ hydrocarbon oil suitable as, or for use in the production of a drilling mud, technical or medicinal grade white oil, solvent, chemical raw material, monomer, polymer, emulsion, or specialty product produced by upgrading a hydrocarbon product obtained by converting a mixture of hydrogen and carbon monoxide via a carbon monoxide hydrogenation reaction by contact, at reaction conditions, with a catalyst comprising a powder, or particulate solids support, and a metal, or metals, catalytically active for conducting said carbon monoxide hydrogenation reactions, made by the steps of a process characterized by any of claims 1 through 10.
